(19) United States
(12) Patent Application Publication
(10) Pub. No.: US 2021/0301894 A1
(43) Pub. Date: Sep. 30, 2021

(54) WEAR SENSING

(71) Applicant: SAF-HOLLAND GmbH, Bessenbach (DE)

(72) Inventors: Mark Hartmann, Sulzbach am Main (DE); Bernd Brunsch, Dreieich (DE)

(21) Appl. No.: 16/328,589

(22) PCT Filed: Sep. 8, 2017
(86) PCT No.: PCT/EP2017/072559

§ 371 Date: Feb. 26, 2019

(30) Foreign Application Priority Data
Sep. 9, 2016 (DE) 10 2016 116 998.6

(51) Int. Cl. F16D 66/02; B60T 17/22

(52) U.S. Cl. CPC F16D 66/023; F16D 66/024; F16D 66/025; B60T 17/221

(57) ABSTRACT

A brake system and wear monitoring for use in motor vehicles includes a transponder, wherein the transponder is configured and positioned in the brake system such that the transponder is deactivated by an engagement geometry of the brake system when a preselected wear state of the brake system is reached.

### BACKGROUND OF THE INVENTION

The present invention relates to wear sensing, in particular in order to be able to ascertain and indicate brake wear on a motor vehicle.

The prior art has already disclosed possibilities for monitoring the wear state of the brake shoes or lining elements and of the brake disk or brake drum using electronic sensors and for issuing warning messages if the brake wear has exceeded a specific magnitude. Furthermore, the prior art has also disclosed mechanically operating wear indicators which optically or haptically provide the user of a motor vehicle with an indication of the wear state of the brake system of the motor vehicle. A disadvantage of the electrically operated wear indication systems known from the prior art is that cabling and connection of the wear sensors to a voltage source and a monitoring unit are always necessary. For this purpose, cables have to be laid in the partly temperature-critical region of the brake, wherein the susceptibility to faults and sensitivity of these cables laid in the brake region are sometimes very high. Consequently, the reliability of the wear indication devices known from the prior art is not high enough to satisfy the requirements in respect of safety and at the same time to enable the brake linings to be utilized in an economically viable way. The mechanical wear sensors are often not accurate enough and moreover require in some instances major structural interventions in the brake system of the motor vehicle.

It is an object of the present invention to provide an improved possibility for ascertaining the wear state of a brake system of a motor vehicle, wherein in particular the intervention in the structural design of the brake system is intended to be minimized.

### SUMMARY OF THE INVENTION

According to the invention, the brake system comprises a transponder, wherein the transponder is designed and positioned and/or secured in the brake system so that it is deactivated by an engagement geometry of the brake system when a preselected or predefined wear state of the brake system is reached. The transponder is an electrical circuit designed with an antenna for analog reception and transmission of an electrical signal, in particular electromagnetic waves. According to the invention, the transponder is arranged and secured in a brake system in such a way that if the brake system reaches a specific wear state, the transponder is deactivated by an engagement geometry of the brake system. In this case, in one embodiment, the transponder can be deactivated by the transponder being destroyed. As an alternative thereto, the engagement geometry can also cover or shield the transponder in such a way that a signal from the transponder can no longer advance to a reader arranged outside the brake system. In other words, the state in which the transponder is deactivated is the state in which no signal passes from the transponder to a reader situated outside the brake system. This state is an indication to the user of the brake system that the wear in the brake system has progressed in such a way that maintenance of the brake system must be carried out.

Preferably, the transponder is configured as an RFID (radio-frequency identification) chip. RFID chips are commercially available in a very cost-effective way. In this case, the transponder configured as an RFID chip can be perfectly adapted in particular to the requirements of the respective installation position in the brake system. In this regard, the transponder can in particular be accommodated in a protective enclosure or be protected by the latter, by means of which the transponder is in each case protected both against high temperatures (up to 300° C.) and against mechanical influence of foreign bodies in the region of the brake system. Particularly preferably, the transponder or its protective enclosure can in this case additionally be provided with an outer geometry which allows an at least partial positively locking engagement of the transponder with its respective engagement geometry on the brake system.

With further preference, the transponder is preferably designed as a passive RFID chip. The advantage of a passive RFID chip is that the latter does not require a dedicated energy supply such as, for example, a battery or electrical connections in order to transmit a signal to a reader. Rather, the transponder designed as a passive RFID chip is fed from the radio waves which are emitted by the reader and which excite the transponder, in particular a resonant circuit of the transponder, and generate a specific response signal in the transponder. Said response signal is sent back via the antenna of the transponder in the direction of the reader and is identified and assigned there. Particularly advantageously, the configuration as a passive RFID chip enables the transponder to be arranged in a very small fashion and completely autonomously, i.e. without a dedicated energy supply, on the brake system. Advantageously, this does not necessitate any changes to the geometry of the brake system. Even the increase in weight as a result of the arrangement of a transponder in the brake system is negligible since transponders designed as passive RFID chips substantially do not exceed a mass in the single-digit gram range.

Advantageously, the transponder is cohesively secured to the brake system. In particular, an adhesive connection or a soldering connection can be used for securing the transponder. Adhesive connections have the advantage that they can be produced in a simple manner between different, including nonmetallic, materials. Particularly preferably, by way of an adhesive connection the transponder can be secured to exterior geometries of the brake system which are reached particularly reliably by the engagement geometry of the brake system. In this way, it is possible to ensure a reliable deactivation of the transponder when the preselected wear state of the brake system is reached. If secure detachment and removal of the transponder from the brake system can be ensured, for the purpose of deactivating the transponder it is sufficient for the latter to be detached from the brake system by the engagement geometry, irrespective of whether or not it is also destroyed in the process. In this case, too, a user with a reader directed at the brake system ascertains that the lining wear has reached a limit value. Advantageously, in the case of this variant of the brake system, no residues of the transponder remain on the brake system.

Advantageously, the transponder is secured to one of the moving parts of the brake system, wherein in the event of a relative movement of the moving part relative to a stationary part of the brake system, an engagement geometry of the stationary part destroys the transponder by mechanical action or shields it toward the outside from electromagnetic waves. Advantageously, in the case of an adhesive connection of the transponder on the brake system, the deactivation of the transponder can also consist in the latter being scraped off and detached from its fixing geometry on the brake system. Particularly preferably, a brake shoe or an actuation piston of the brake is regarded as a moving part of the brake system. With further preference, the lining carrier, an S-cam or an expanding wedge of the brake system are defined as moving parts of a brake system. In other words, in particular the parts of the brake system which move relative to the brake carrier, which is in turn secured to the chassis of the motor vehicle, should be regarded as moving parts. In this respect, a brake caliper, which in turn has two lining elements moving relative to the brake caliper, should also be regarded as a moving part within the meaning of the present invention. The advantage of the arrangement of the transponder on a moving part of the brake system is that in particular in the case of disk brakes or drum brakes, the actuation travel of the respective brake lining element and of the associated components is directly related to the wear that has already taken place on the lining element. In this respect, the magnitude or the travel distance of the actuation travel is a direct indicator of the wear of the brake system. This relationship can be utilized by the transponder being secured to the moving part, which is connected in particular to the brake shoe, the brake lining or the lining carrier, and thus being covered and shielded or destroyed in the event of a specific travel distance being reached by an engagement geometry provided on the stationary part of the brake system, such as the brake carrier or a housing of the brake system. As a result, in a particularly simple manner, it is possible to determine the envisaged limit wear as a function of a specific fixing position of the transponder on the moving part of the brake system and to set it with correspondingly high accuracy.

With further preference, the transponder is secured to a first moving part of the brake system, wherein in the event of a relative movement of the first moving part relative to a second moving part of the brake system, the second moving part destroys the transponder by mechanical action or shields it vis-à-vis electromagnetic radiation. As an alternative to the transponder being secured to the stationary part of the brake system, the transponder can also be secured to a first moving part of the brake system, which is in relative movement with respect to a second moving part. The effect achieved here, namely that the attainment of a specific relative movement state between the two moving parts means that destruction or shielding of the transponder leads to the inoperability thereof, is similar to the design variants described above. In particular, the transponder in this case can be secured to an actuation element which moves for example relative to a floating caliper of the brake system. In this case, the floating caliper should likewise be regarded as a moving part in relation to the brake carrier of the brake system. In this case, in particular as a result of the engagement geometry striking against the transponder, said engagement geometry being provided either on the brake caliper or on the actuation element, said transponder can be deactivated. Advantageously, the transponder is secured on the inner side of a brake caliper in such a way that it is destroyed by a lining carrier of the brake system when a preselected actuation travel is reached. In the case of the arrangement of the transponder on the inner side of the brake caliper, the latter is thermally insulated from the friction partners of the disk brake system. A longer lifetime of the transponder should be expected as a result. In the event of a lining change after a maximum wear state of the lining elements has been reached, a new transponder is adhesively bonded onto the inner side of the brake caliper, preferably at the same position as the destroyed transponder used previously.

Preferably, the transponder is held in a cutout in a brake lining element. In this case, the brake lining element is advantageously a lining element of a disk brake or a brake shoe. Particularly preferably, the transponder in this case projects with a section necessary for its functionality, such as a loop of the resonant circuit or the antenna, into the region of the brake lining. As a result of wear and thus reduction of the brake lining thickness, proceeding from a specific limit value, the transponder is also abraded by the drum brake or the brake disk and thus deactivated. What is particularly advantageous here is that after the destruction of the transponder, the latter together with the brake lining element can be replaced by a new brake lining element with a new, functional transponder. Detachment of the transponder from the brake lining element or similar additional work steps are not required in this case.

With further preference, the transponder is placed onto a brake lining carrier and held there. As an alternative to the transponder being introduced into a cutout provided for it on the brake lining element, said transponder can also be placed laterally or next to the brake lining onto the brake lining carrier, such as, for example, the brake shoe web or the lining carrier plate of a lining element for a disk brake, and can be held there. For this purpose, a cohesive connection is appropriate, in particular, although the latter can alternatively or additionally be produced or reinforced by a for example force-locking connection. What is advantageous about simply placing the transponder onto the respective brake carrier is that no changes or structural interventions in existing brake elements whatsoever are required and the lining carrier of a standard brake system can be equipped with a transponder according to the present invention.

Particularly preferably, the transponder is adhesively bonded onto a lining holding spring which is able to be secured to a brake system and to a brake lining carrier in a positively locking and/or force-locking manner. When the transponder is secured to a lining holding spring, it can be provided jointly with the spring, particularly if a new brake lining is fixedly clamped to the lining carrier plate by way of the lining holding spring and, if appropriate, is additionally secured in a positively locking manner. In this case, in particular, it is possible to provide lining holding springs with a transponder arranged thereon independently of the size and geometry of the brake lining of the brake system. The versatility of usability and also the production costs for wear monitoring can be significantly improved as a result. Moreover, if the brake lining is exchanged before the limit wear is actually reached, and the transponder has accordingly not yet been deactivated, the lining holding spring together with the transponder can be used anew.

Particularly preferably, the transponder is able to be secured to an actuation element of the brake system, wherein in the event of a preset actuation travel being exceeded, the transponder is deactivated by mechanical action of the stationary part of the brake system. As an alternative or in addition to a transponder being secured on one of the fixing positions described above, a transponder can be secured, preferably adhesively bonded, to an actuation element of the brake system. In a manner similar to the utilization of the actuation travel of the lining elements and the lining carrier elements, in the case, too, of the actuation element, for example the piston of an expanding wedge unit for a drum brake or the actuation cylinder of a disk brake system, the distance covered by the actuation element together with the transponder can be used as an indicator of the wear of the brake system. In a manner corresponding to the fixing position of the transponder, in this case the engagement geometry is configured in such a way that it either destroys the transponder or shields the latter from externally introduced electromagnetic waves. Advantageously, the transponder, in the case of being secured to the actuation element of the brake system, can be transferred into regions of the brake system in which temperatures are lower than those transferred at the lining elements, such as the brake shoes or lining carriers of the brake system. This ensures reliable use of the transponder particularly during continuous operation of the brake.

Preferably, the transponder is secured to a rivet element for fixing the brake lining to the brake lining carrier, wherein the rivet element and the transponder are arranged in a cutout on the brake lining. Particularly for the preferred case where the lining pads are applied and secured on the brake lining carrier by means of rivets, the heads of the rivets can be used for arranging and securing transponders thereon. In particular, in this case the rivet element or the head of the rivet element and the transponder are countersunk jointly in a cutout on the brake lining. As soon as the brake lining has reached a specific wear state and been abraded by a specific thickness, the transponder is also ground away by the brake disk or the brake drum of the brake system and finally deactivated. For use directly on the brake lining, the transponder preferably has a particularly high thermal loading capacity.

Alternatively or additionally preferably, the transponder is secured to a shaft of an S-cam of a drum brake in such a way that in the event of a specific rotation angle of the S-cam being reached, the transponder is shielded toward the outside by a covering geometry formed on the housing of the brake system. Particularly in order to improve the accessibility of the transponder for electromagnetic waves in the case of a drum brake, said transponder can be arranged on the shaft of an S-cam for actuating the drum brake. In this case, the transponder is rotated together with the S-cam, wherein a specific rotation angle positon of the S-cam upon the bearing of the brake system represents a specific wear state of the brake system. Advantageously, a covering geometry is provided on the housing of the brake system and covers the transponder in the maximally rotated state of the S-cam proceeding from a specific wear of the brake system in such a way that no electromagnetic waves can be transmitted toward and away from the transponder.

In a further preferred embodiment, the transponder is suspended via at least one connection element between two brake shoes of a drum brake, wherein a predetermined breaking location is provided in the region of the transponder and wherein the brake shoes tear the transponder apart upon reaching a preselected spacing from one another. This very simple embodiment allows the transponder to be inserted into an existing brake system, wherein the transponder is suspended between two brake shoes of a drum brake in a manner similar to the installation position of a restoring spring. The connection element provided for arranging and securing the transponder between the brake shoes is in this case preferably of stabler design than the region of the transponder itself, wherein a predetermined breaking location is thereby provided on the transponder. When specific wear is reached on the brake shoes of the drum brake, said brake shoes have to be spaced further from one another in order to continue to make contact with the brake drum. In this case, it is possible to preselect a specific limit value of the spacing of the two brake shoes proceeding from which the transponder is torn apart by the connection element and indirectly by the brake shoes moving apart from one another.

In a furthermore preferred embodiment, the transponder can be arranged on an S-cam of a drum brake in such a way that when a specific rotational angle of the S-cam is reached, the transponder is destroyed directly or indirectly by a brake shoe engaging on the S-cam. Advantageously, the rotational position of the S-cam proceeding from which the transponder is destroyed can be set accurately in this case.

In an alternatively preferred embodiment, the transponder is secured to a stationary part of the brake system, wherein in the event of a relative movement of a moving part of the brake system relative to the stationary part, the moving part deactivates the transponder by mechanical action or shielding. As an alternative to the transponder being secured to the moving part of the brake system, said transponder can also be arranged on the stationary part. This has the advantage that the transponder in particular in its position relative to the chassis of the commercial vehicle is always at the same position. As a result, independently of the actuation state of the brake system, the reader can always reach a specific access angle for electromagnetic radiation with respect to the transponder. With further preference, by being secured to the stationary part of the brake system, the transponder is subjected to a lesser extent to acceleration forces and thus a potential reduction of the lifetime as a result of these periodic load changes.

The invention provides wear monitoring comprising a transponder and a reader, wherein the transponder is fitted to the brake system in such a way that it becomes inoperative as soon as a lining element assigned to the transponder reaches the wear limit, wherein the reader activates the transponder with electromagnetic radiation and determines the state of said transponder and conditions it for a receiver or user. The transponder is preferably an RFID chip provided on the brake system, in accordance with one of the embodiments described above. The reader preferably has a source of electromagnetic radiation and at the same time the possibility of reading out the response signal of a transponder designed as a passive RFID chip and of conditioning said signal and making it visible for a user. In this case, the position of the reader is determined according to the accessibility of the transponder in the brake system. Advantageously, the reader is equipped with a transmission intensity which allows all transponders arranged on a commercial vehicle to be addressed from outside the commercial vehicle, that is to say preferably in a range of four to eight meters, and the response signals of the transponders correspondingly to be individually detected and conditioned and indicated for a receiver or user of the wear monitoring.

Advantageously, the reader in this case monitors a multiplicity of transponders and communicates the state thereof to a receiver or user. In this case, a first state of the respective transponder is that the latter replies and the wear limit of the lining element assigned to this transponder has thus not yet been reached. If the reader does not receive a response signal from a transponder provided on the motor vehicle, it communicates this information to the user, who can thereupon carry out an exchange of the corresponding lining element. Preferably, the reader in this case has a memory in which the transponders planned or installed for a specific vehicle and their respective fixing position and also their identifier are stored, wherein the reader compares this desired state of the motor vehicle with the actual state determined, i.e. the number and identifier of the transponders which respond to an excitation signal of the reader.

As a result, the receiver can determine, or it is possible for a user to determine at first glance, whether and which transponders of the brake system no longer respond and to which brake systems, i.e. to which individual brake shoe or brake drum or disk brake, said transponders are assigned. In this case, it is particularly advantageous to use a schematic graphic which, for the respective transponder, graphically conditions the installation position thereof on the chassis of the motor vehicle, in particular of the commercial vehicle, in a simple manner.

In a first preferred embodiment, the reader in this case is installed on the vehicle and able to monitor the wear state of at least one brake system both when the vehicle is stationary and while the vehicle is traveling. Particularly preferably, the reader in this case is installed in the region of the underbody of the vehicle and is able at regular intervals to transmit an interrogation to the respective transponders and, by means of the response signals received from the transponders, to determine whether all transponders in the region of the chassis of the commercial vehicle or motor vehicle are functional. Particularly in the case of commercial vehicles, which involve only short downtimes and overall high time pressure in the dispatch processing of the commercial vehicles, the state of all the transponders arranged in the respective brake systems can in this way be indicated directly to the driver of the commercial vehicle by means of a display provided in the cockpit. In this case, a remaining usability of the respective brake systems after the failure of a transponder and thus after reaching a specific wear limit could also be indicated by the monitoring system.

Alternatively preferably, the reader is installed outside the vehicle and is designed, as the vehicle travels past, to determine the state of one transponder or of a multiplicity of transponders. Particularly for the case where a commercial vehicle fleet or for example a fleet of rental cars or company cars is provided, a reader can be arranged in the region of the entrance or exit of a central parking area or company site, which reader, for each of the vehicles, determines the state of the transponders arranged on the vehicle and communicates it to a central monitoring unit. In this way, by virtue of this information, the fleet management can directly plan maintenance work for the respective vehicles and have it carried out. Furthermore, it is only necessary to procure a single reader for an entire fleet and a plurality of transponders on each vehicle. In this way, a reliable and optimized operational procedure can be achieved since maintenance intervals do not have to be fixed, but rather can be geared to the actual wear of the brake system.

### BRIEF DESCRIPTION OF THE DRAWINGS

Further advantages and features of the present invention will become apparent from the following description with reference to the accompanying figures. It goes without saying here that individual features disclosed in only one of the embodiments shown can in each case also find application in further embodiments shown in other figures, provided that this is not prohibited or has been explicitly excluded on account of technical circumstances. In this case, FIGS. 1-10 respectively show embodiments of brake systems with transponders arranged thereon. FIG. 11 schematically shows one preferred embodiment of a system for wear monitoring.

FIG. 1 shows a transponder 2 secured to a lining element of a disk brake. In this case, the lining element, which is composed of the brake lining itself and also the lining carrier, is identified in particular as a first moving part 3A. The illustration shows here that when a specific residual thickness d of the brake lining is reached, the transponder 2 is abraded by the brake disk and thereby deactivated.

FIG. 2 shows an embodiment in which the transponder 2 is secured to the stationary part 5 of a brake system and is destroyed and thus deactivated when a specific relative movement of the moving part 3 of the brake system is reached. The stationary part 5 is preferably a housing of an actuation installation for a disk brake, said housing being connected to the brake carrier. The moving part 3 is preferably a brake lining element, which is pressed toward the left in the figure against the brake disk illustrated on the left in the figure. As soon as the brake lining has experienced a certain wear and the lining carrier thus has to be displaced further toward the left in order to bring the lining into contact with the brake disk, the transponder 2 is contacted and finally destroyed by the engagement geometry provided on the top side of the moving part 3.

FIG. 3 shows a preferred embodiment in which the transponder 2 is secured on a moving part 3A designed as a rivet. What is not shown here is that a second moving part 3B, preferably the brake drum, abrades and thus deactivates the transponder when a specific wear is reached.

The embodiment shown in FIG. 4 is similar to the embodiment shown in FIG. 3 apart from the feature that the transponder is not arranged on the rivet of the brake shoe, but rather in the front region of the brake lining. As also in the embodiment shown in FIG. 3, the transponder 2 here is abraded and destroyed by a second moving part 3B, preferably the brake drum, if the lining element functioning as the first moving part 3A has experienced a specific wear.

FIG. 5 shows the preferred embodiment of the brake system according to the invention in which the transponder 2 is suspended between two brake shoes of a drum brake. Preferably, a predetermined breaking location is provided in the region of the transponder 2 and ensures that the transponder is torn apart and thus deactivated in the event of a specific spacing of the two brake shoes from one another. The brake shoes are defined as first moving part 3A and second moving part 3B.

FIG. 6 shows a preferred embodiment of the brake system in which the transponder 2 is secured on the first moving part 3A configured as an S-cam of the drum brake. When a specific wear is reached, the transponder 2 in this case is contacted and destroyed by the second moving part 3B. Advantageously, in this case, two transponders 2 can be provided on the S-cam, wherein a respective transponder 2 is assigned to one of the brake shoes.

FIG. 7 shows a further preferred embodiment in which the transponder 2 is arranged on the shaft of an S-cam and is rotated together with said shaft about the dash-dotted line. In this case, an engagement geometry is arranged on the housing of the brake system, which should be regarded as a stationary part 5, which engagement geometry destroys the transponder or shields it from electromagnetic radiation when a specific rotational position of the shaft of the S-cam is reached, said shaft being configured as a moving part 3.

FIG. 8 discloses a further preferred embodiment in which the transponder 2 is arranged in a brake disk, which should be regarded as a first moving part 3A. Since the transponder 2 has a specific thermal loading capacity, it can be used both for indicating the wear of the brake disk and for indicating temperature spikes. In this regard, if the temperature has exceeded a specific limit value and it must thus be feared that there may be material damage in the material of the brake disk, the transponder can be deactivated by the thermal overload, this being communicated to the user of the brake system by the absence of a response signal from this transponder. In this embodiment, the lining element comprising the brake lining and the lining carrier should be regarded as a second moving part 3B.

FIG. 9 shows a further preferred embodiment of the present invention, wherein the transponder 2 is secured to a stationary part 5 in the chassis system of the motor vehicle. As a moving part 3 within the meaning of the present invention, use is made of the actuation lever for the S-cam, which contacts the transponder 2 when a specific deflection position (arrow) is reached, and destroys the transponder 2 when said deflection position is overshot. In this embodiment, the transponder 2 can be used both for indicating the brake shoe wear and for indicating the function of the adjusting device on the S-cam. If the adjusting device is not functioning, then as the wear of the brake shoes increases, the deflection movements of the actuation lever become larger and larger, with the result that finally a maximum deflection is reached, accompanied by destruction of the transponder 2. If the transponder 2 in the embodiment shown in FIG. 9 is thus deactivated, then this should be interpreted by a user as an indication of exhaustion of the adjustment range of the adjusting device owing to excessively high wear of the linings or as an indication of a fault in the adjusting device.

FIG. 10 shows an embodiment of a brake system according to the invention which is very similar to the embodiment shown in FIG. 7. Once again the transponder 2 is arranged and secured on the actuation shaft for an S-cam functioning as a moving part 3. When a specific rotational angle position of the shaft of the S-cam is reached, the transponder 2 is contacted and destroyed by an actuation geometry provided on the stationary part 5. In this embodiment, it is appropriate once again for a predetermined breaking location to be provided in the transponder in order to prevent the transponder 2 from simply just being scraped off the shaft and still remaining functional in the region of the housing of the brake actuation system.

FIG. 11 discloses a wear monitoring system, comprising a transponder 2 and a reader 4, wherein the reader 4 is designed to monitor a plurality of transponders 2 which are preferably configured according to one of the embodiments described above and arranged in the respective brake system. Preferably, as shown in FIG. 11, the reader 4 is arranged in the region of the ground for example at the entrance to a pool of motor vehicles, particularly preferably commercial vehicles.

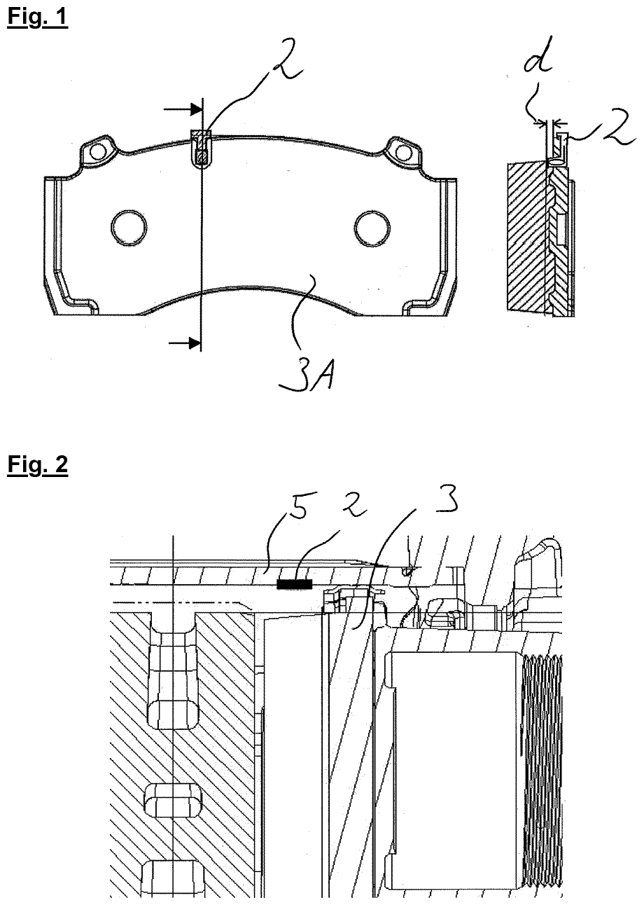

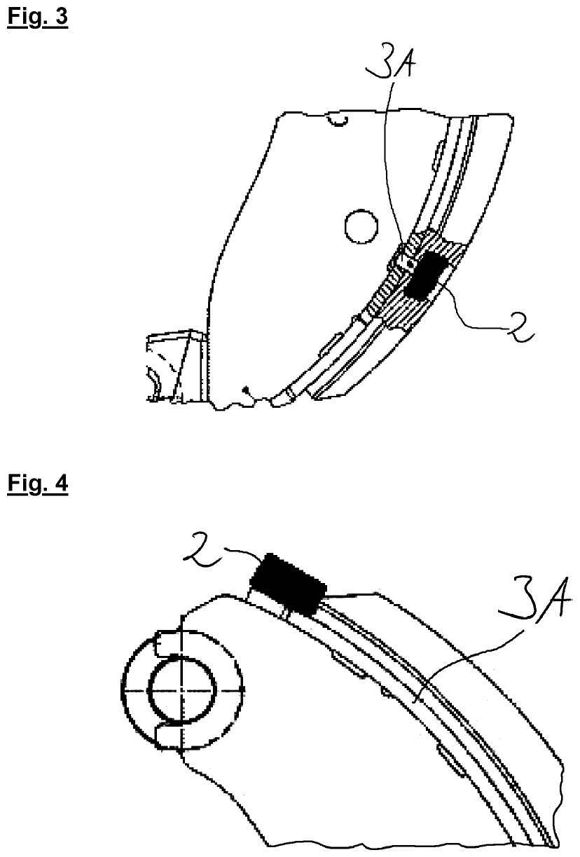

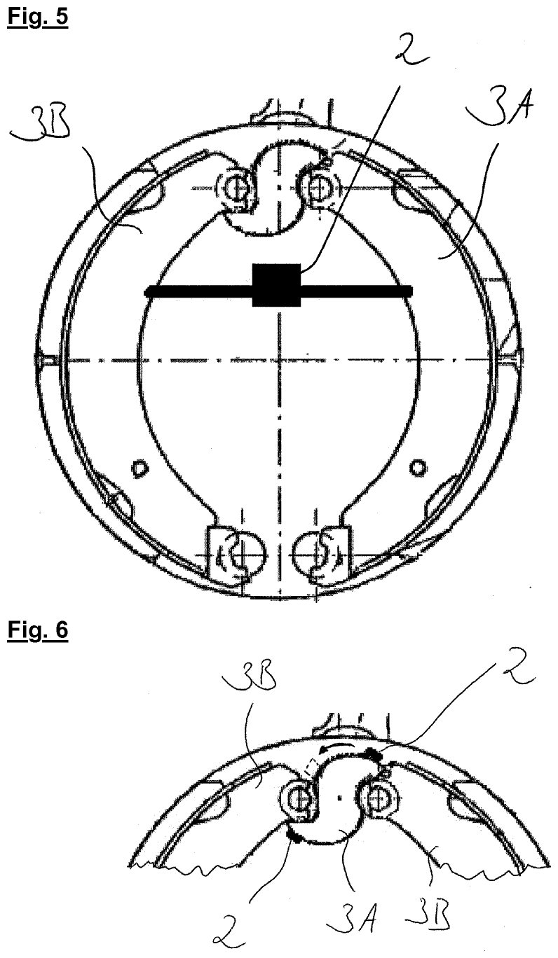

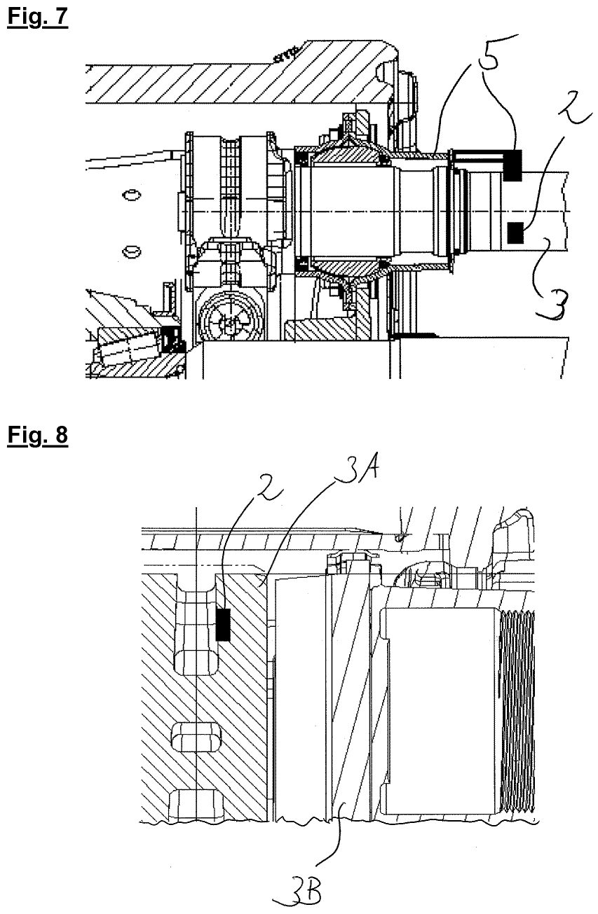

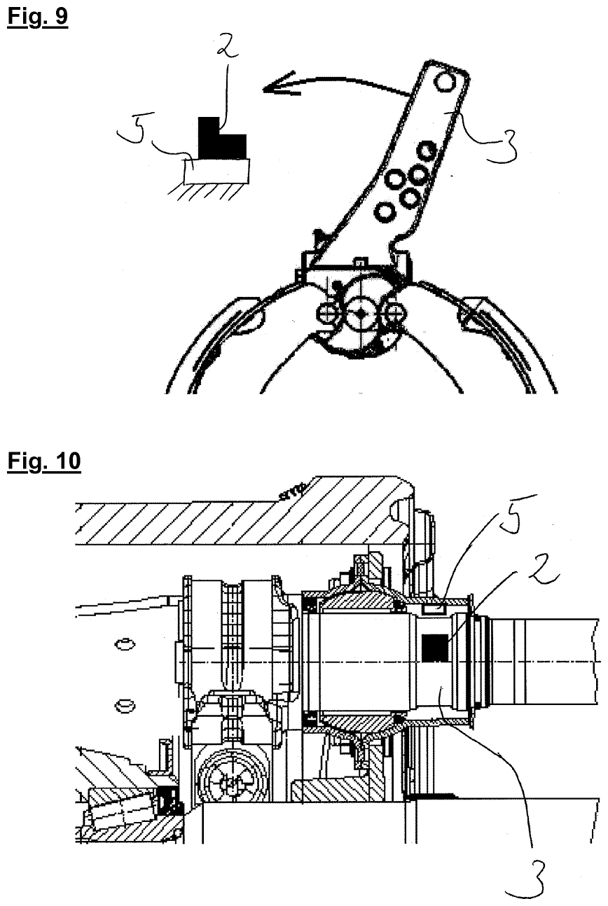

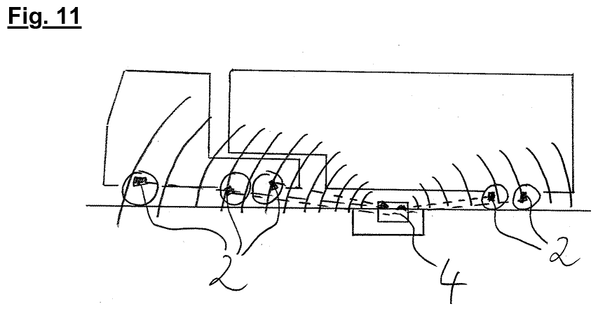

### REFERENCE SIGNS

2—Transponder
3—Moving part
3A—First moving part
3B—Second moving part
4—Reader
5—Stationary part
d—Residual thickness

1.-15. (canceled)

16. A brake system for use in motor vehicles, comprising:
a transponder, configured and positioned in the brake system so that the transponder is deactivated by an engagement geometry of the brake system when a predeterminable wear state of the brake system is reached, wherein the transponder is secured to a stationary part of the brake system, and
wherein in the event of a relative movement of a moving part relative to the stationary part, the moving part deactivates the transponder.

17. The brake system as claimed in claim 16, wherein the transponder includes a passive RFID chip.

18. The brake system as claimed in claim 17, wherein the transponder is cohesively secured to the brake system.

19. The brake system as claimed in claim 18, wherein the stationary part of the brake system includes at least one of a brake carrier and a housing.

20. The brake system as claimed in claim 16, wherein the transponder is cohesively secured to the brake system.

21. The brake system as claimed in claim 16, wherein the stationary part of the brake system includes at least one of a brake carrier and a housing.

22. A wear monitoring system, comprising:
a transponder; and
a reader;
wherein the transponder is fitted to the brake system such that the transponder becomes inoperative as soon as a lining element assigned to the transponder reaches the wear limit;
wherein the reader activates the transponder with electromagnetic radiation and determines a state of the transponder and conditions the transponder for a receiver;
wherein the transponder is secured to a stationary part of the brake system; and
wherein in the event of a relative movement of a moving part relative to the stationary part, the moving part deactivates the transponder.

23. The wear monitoring system as claimed in claim 22, wherein the reader is installed outside of a vehicle and is configured to determine the state of one transponder or of a multiplicity of transponders as the vehicle travels past the transponder.

24. The wear monitoring system as claimed in claim 23, wherein the one transponder is one of a plurality of transponders.
